(19) United States
(12) Patent Application Publication
(10) Pub. No.: US 2026/0317503 A1
(43) Pub. Date: Oct. 15, 2026

(54) DISSOLUTION OF NYLON 6 AND NYLON 6,6 IN NATURAL DEEP EUTECTIC SYSTEMS IN TEXTILE RECYCLING

(71) Applicant: Bioeutectics Corporation, Wilmington, DE (US)

(72) Inventors: Tomás Silicaro, Tulsa, OK (US); Benjamin Viada, Mendoza (AR); Maria Celeste Dalfovo, Mendoza (AR)

(73) Assignee: Bioeutectics Corporation, Wilmington, DE (US)

(21) Appl. No.: 19/643,074

(22) Filed: Apr. 9, 2026

Related U.S. Application Data
(60) Provisional application No. 63/785,660, filed on Apr. 9, 2025.

(51) Int. Cl. C08J 11/08

(52) U.S. Cl. CPC C08J 11/08; C08J 2375/04; C08J 2377/02; C08J 2377/06

(57) ABSTRACT

Eutectic solvent products and associated methods are disclosed for the recovery and/or recycling of various polymers that otherwise are difficult to recover and/or recycle. The eutectic solvents are superior to currently used products and methodologies because they tend to be less toxic while still being able to get good to excellent recovery yield. The polymers that can effectively be recovered and/or recycled using the eutectic solvents of the present invention include but are not limited to polyamides such as nylons, polyether ether ketone (PEEK), polyphenylene sulfide (PPS), polyester, polyurethane, polystyrene (Telgopor or Styrofoam^{TM}), and polyethylene terephthalate (PET). Polyamides that can be effectively recycled and/or recovered include nylon and nylon 6,6.

This application claims priority under 35 USC 119(e) to US Provisional Application No. 63/785,660 filed Apr.9, 2025, the entire contents of which are hereby incorporated in its entirety.

### FIELD OF THE INVENTION

The present invention relates to methods and natural eutectic solvent systems for the recovery and/or recycling of various polymers that otherwise are difficult to recover and/or recycle. The eutectic solvents are superior to currently used products and methodologies because they tend to be less toxic while still being able to get good recovery yield. The polymers that can effectively be recovered and/or recycled using the eutectic solvents of the present invention include but are not limited to polyamides such as nylons, polyether ether ketone (PEEK), polyphenylene sulfide (PPS), polyester, polyurethane, polystyrene (Telgopor or Styrofoam^{TM}), and polyethylene terephthalate (PET). Polyamides that can be effectively recycled and/or recovered include nylon 6 and nylon 6,6.

### BACKGROUND OF THE INVENTION

Deep eutectic solvents or DESs are solutions of Lewis or Brønsted acids and bases which form a eutectic mixture. Deep eutectic solvents are highly tunable by varying the structure of the components or by varying the relative ratios of various components in the mixture. Because these are complicated systems that have widely varying properties, they have a wide variety of potential applications, including their use in catalysis, separation techniques, and electrochemical processes. The parent components of deep eutectic solvents tend to engage in complex hydrogen bonding networks, which means that the mixture tends to have significant freezing point depressions relative to the parent compounds/components in the mixture. Sometimes the individual components in the mixture may be solids at room temperature and atmospheric pressure, but when they are mixed together at room temperature and atmospheric pressure, the mixture may be a liquid that has a severely depressed freezing point (e.g., 10^{o}C).

The term “eutectic” was first coined in 1884 by British chemist and physicist Frederick Guthrie. The first generation of eutectic solvents were based on mixtures of quaternary ammonium salts with hydrogen bond donors such as amines and/or carboxylic acids. Natural deep eutectic solvents (NADES) are biologically based deep eutectic solvents which are composed of two or more compounds that are generally plant based primary metabolites, i.e., organic acids, sugars, alcohols, amines and amino acids. Water may also be present as part of the solvent, as water is sometimes difficult to remove due to its inability to be easily evaporated.

Much of the study of eutectic solvents since Frederick Guthrie coined the term “eutectic” has involved solvent mixtures wherein at least one of the components is a metal based solvent. However, the discharge of metals from these solvent systems has demonstrated many of the drawbacks associated with metal leaching, and its associated health, environmental, and safety related issues. Accordingly, there has been some recent interest in non-metal containing eutectic systems.

Polymers play a crucial role in modern manufacturing and technology, offering a wide range of applications due to their mechanical strength, chemical resistance, and versatility. Among the most widely used polymers are polyamides (nylon 6 and nylon 6.6), polyether ether ketone (PEEK), polyphenylene sulfide (PPS), polyester, polyurethane, polystyrene (Telgopor), and polyethylene terephthalate (PET). These materials are employed in industries ranging from automotive and aerospace to packaging and textiles. However, the growing demand for polymers, along with their persistence in the environment, has led to significant concerns about their disposal and recyclability.

One of the major challenges in the recycling and reuse of polymers lies in their dissolution, which is a critical step for repurposing the material. Many of these polymers, particularly high-performance ones like PEEK, PPS, and nylon, are resistant to dissolution due to their strong intermolecular forces, crystallinity, and chemical stability. For example, polyamides such as nylon have strong hydrogen bonding between polymer chains, while PEEK exhibits high thermal and chemical stability, making both polymers notoriously difficult to dissolve. Similarly, PET and polystyrene are widely used in packaging but require harsh conditions or aggressive solvents for effective dissolution.

Traditionally, the solvents used to dissolve these polymers include strong acids, chlorinated solvents, and other organic chemicals that are both hazardous and environmentally unfriendly. Solvents such as formic acid, dimethylformamide (DMF), dichloromethane, and trichloroethylene, although somewhat effective in dissolving tough polymers, present serious health risks, including toxicity, carcinogenicity, and high volatility. Their use poses threats not only to human health but also to the environment, as their release into ecosystems leads to water and soil contamination, bioaccumulation, and long-term ecological damage.

In response to these challenges, the field of green chemistry has sought alternatives to traditional solvents by focusing on sustainability, safety, and environmental impact. One promising solution lies in the use of eutectic systems, particularly Natural Deep Eutectic Solvents (NADES), which have gained attention due to their non-toxic nature, biodegradability, and high solvation power. Eutectic systems are formed by mixing two or more compounds that interact to lower the melting point of the mixture, creating a liquid solvent at room temperature. NADES, in particular, offer unique advantages, such as tunable physicochemical properties, minimal volatility, and the ability to dissolve a wide variety of substances, including those that are insoluble in traditional solvents.

Nylon, a synthetic polyamide introduced in the 1930s, has become essential across multiple industries, with applications in textiles, reinforcement materials, molded products, and packaging. By 2020, this petroleum-derived thermoplastic represented 5% of the global fiber market, with production increasing from 3.74 million tonnes in 1990 to 5.4 million tonnes. However, growing environmental concerns related to textile waste have highlighted the need for efficient recovery processes to reclaim nylon and reduce its environmental impact.

### BRIEF SUMMARY OF THE INVENTION

This invention relates to and aims to explore the potential of eutectic systems for dissolving polymers that are notoriously difficult to process, such as nylon 6, nylon 6.6, PEEK, PPS, polyester, polyurethane, Telgopor, and PET. By investigating the interaction between these polymers and various eutectic solvents, this invention relates to and seeks developing eco-friendly methods for polymer dissolution that could be applied to recycling and material recovery processes. Understanding the mechanisms of polymer dissolution in eutectic systems should lead to innovative approaches to polymer waste management, significantly reducing the environmental footprint of plastic production and disposal.

Moreover, this invention addresses key questions about the efficiency and limitations of eutectic solvents, considering factors such as solvent polarity, hydrogen bonding, and viscosity in relation to the dissolution process. The results should contribute to the broader application of eutectic systems in industrial processes, supporting a circular economy where polymers are more easily recycled, reused, and reintegrated into production chains without relying on harmful chemical agents.

The invention not only is able to dissolve the various polymers, but these polymers can be recovered using solvents that are less toxic than traditionally used polymer recovery methods. Yields of the recovered polymers are more than satisfactory indicating that eutectic solvents have a promising future in the field.

In an embodiment, the present invention relates to a selective process for the efficient separation and recovery of nylon from textile waste. Because the global nylon market is expected to grow steadily, driven by the rising demand for nylon fibers in garments, ropes, awnings, carpets, and knitted apparel, the ability to separate nylon 6 and nylon 6,6 will be more and more important in the future. Nylon 6 and nylon 6,6 are particularly valued for their abrasion resistance, flexibility, and ability to impart luster to premium fabrics such as chiffon and organza. Furthermore, the increasing use of nylon in consumer products ranging from toothbrush bristles and toy components to musical instrument strings continues to fuel market demand.

Thus, in an embodiment, the present invention relates to the replacement of toxic and hazardous traditional solvents in the nylon recovery process through natural, biodegradable and safe eutectic solvents.

In an embodiment, the present invention relates to the use of eutectic solvents and determining the products and process parameters required to extract pigments from the various polymers. In an embodiment, the present invention relates to achieving objectives that include attaining nylon 6 (CAS 25038-54-5) solubility using eutectic products, while determining the saturation amount and stability of the solution and also ascertaining the recovery yield.

Similarly, another objective is to achieve nylon 6,6 (CAS 32131-17-2) solubility using eutectic products, while determining the saturation and stability of the solution, and ascertain the recovery yield.

In an embodiment, the present invention also relates to recovering nylon from textile waste containing mixed fibers and pigmented fabrics using eutectic products, while determining the saturation and stability of the solution, as well as ascertaining the recovery yield.

In an embodiment the present invention also relates to extracting dyes from nylon textiles to enhance the purity of nylon recovered using eutectic products. That is, getting rid of some of the color of colored nylons, and associated polymer products.

### BRIEF DESCRIPTION OF THE SEVERAL VIEWS OF THE DRAWING

FIG. 1 shows a graph of nylon 6 solubility for various eutectic mixtures, with the MAL/LC mix showing the highest solubility amount.

FIG. 2 shows a saturation curve of nylon 6 solubility in MAL/LC (50:50 MAL is 1:5 ratio of malic acid to lactic acid and LC is a 7:1 ratio of lactic acid to citric acid) over time (in hours).

FIG. 3 shows a graph of nylon 6,6 solubility for various eutectic mixtures, with the TAMAL/LCMA ( 50:50 TAMAL is 1:4.5:25 ratio of tartaric acid, malic acid to lactic acid and LCMA is 1:0.2:0.2 ratio of lactic acid, citric acid to malic acid) mix showing the highest solubility amount.

FIG. 4 shows a graph showing the time for Nylon 6 solubility in TAMAL/LCMA under static conditions and at various stir rates.

FIG. 5 shows Nylon 6 solubility rate (in hours) in TAMAL/LCMA at various temperatures.

FIGS. 6a and 6b show images of solubility of Nylon 6 in TAMAL/LCMA at 120^{o}C and upon cooling to room temperature, respectively.

FIGS. 7a and 7b show images of Nylon 6,6 in TAMAL/LCMA at 100^{o}C after one hour and three hours later, respectively.

FIGS. 8a, 8b and 8c, show images of solubilization of nylon 6,6 pellets upon heating after a time of 15 hours (FIG. 8A) and after cooling wherein the nylon 6,6 pellets solidify (FIG. 8A and 8B).

FIG. 9 shows an image of a blue colored recovered nylon after dissolution and recovery using water as an antisolvent.

FIGS. 10a and 10b show images of black nylon showing the original black nylon and the discolored recovered nylon, respectively.

FIGS. 11a and 11b show images of white nylon showing the original white nylon and the nylon after recovery, respectively.

FIGS. 12a, 12b, and 12c, show images of elastane recovered with slight loss of coloration.

FIG. 13 shows a graph with the maximal dissolution amounts of various types and/or colors of nylon in mg/ml.

FIGS. 14a, 14b, 14c, 14d, and 14e, show images of original fibers on left and 10% by weight and 5 % by weight at 80^{o}C in various eutectic solvents with FIG. 14a being BcC (Coconut Betaine : Citric Acid) (1:0.25), FIG. 14b being BcPG (1:4.5): Coconut Betaine : Propanodiol, and FIG. 14c being UBcC (1:0.5:1.5): Urea : Coconut Betaine : 1,2 propanediol, FIG. 14d being BcL (1:1): Coconut Betaine : Lactic Acid, and FIG. 14e being LBcPG (1:1:1): Lactic Acid : Coconut Betaine : 1,2 propanediol.

FIG. 15 shows an image of successive distilled water additions wherein equal volumes of solvent (water) are used for extraction.

FIGS. 16a and 16b show images illustrating the color of nylon fibers after bleaching (16a) and after recovery (16b) at 10% by weight in UBcPG.

FIGS. 17a and 17b show images illustrating the color of nylon fibers after bleaching (17a) and after recovery (17b) at 5% by weight in UBcPG.

FIG. 18 shows a graph of the yield of the various nylon fibers, which differ in composition and/or color.

FIG. 19 shows the nylon achieved after the application of 3 times of simultaneous solubilization and discoloration of nylon.

FIG. 20 shows a summary of the yields for the various polymer recoveries.

FIGS. 21 and 22 depict FTIR-ATR (Fourier Transform Infrared – Attenuated Total Reflectance) Spectra demonstrating that after recovery, nylon 6,6 and nylon from white thread (red line) maintain the same conformation and structure as at the beginning (blue and green lines).

### DETAILED DESCRIPTION OF THE INVENTION

In an embodiment, the present invention relates to the use of eutectic systems for dissolving polymers that are notoriously difficult to process, such as nylon 6, nylon 6.6, PEEK, PPS, polyester, polyurethane, Telgopor, and PET. By investigating the interaction between these polymers and various eutectic solvents, the present invention intends to develop and be used in an eco-friendly manner using eco-friendly methods for polymer dissolution that could be applied to recycling and material recovery processes. Understanding the mechanisms of polymer dissolution in eutectic systems should lead to innovative approaches to polymer waste management, significantly reducing the environmental footprint of plastic production and disposal.

Moreover, this invention addresses key questions about the efficiency and limitations of eutectic solvents, considering factors such as solvent polarity, hydrogen bonding, and viscosity in relation to the dissolution process. The results should contribute to the broader application of eutectic systems in industrial processes, supporting a circular economy where polymers are more easily recycled, reused, and reintegrated into production chains without relying on harmful chemical agents.

This invention aims to develop a selective process for the efficient separation and recovery of nylon from textile waste. The global nylon market is expected to grow steadily, driven by the rising demand for nylon fibers in garments, ropes, awnings, carpets, and knitted apparel. Nylon 6 and nylon 6,6 are particularly valued for their abrasion resistance, flexibility, and ability to impart luster to premium fabrics such as chiffon and organza. Furthermore, the increasing use of nylon in consumer products ranging from toothbrush bristles and toy components to musical instrument strings continues to fuel market demand.

In an embodiment, the present invention relates to the replacement of toxic and hazardous traditional solvents in the nylon recovery process using natural, biodegradable and safe eutectic solvents.

Accordingly, the present invention attains specific objectives such as identifying ideal products to effectuate recycling and/or recovery, while determining the ideal process parameters that allow the eutectic solvents to perform recycling and/or recovery actions and associated processes such as extracting pigments from the polymers. Lower–molecular weight recycled nylon obtained through the present process may be advantageously utilized across a range of industrial applications, including but not limited to formulations for paints, coatings, and adhesive systems, where its modified physicochemical properties enhance processability and performance.

### Specific Objectives

In an embodiment, the present invention is able to achieve nylon 6 (CAS 25038-54-5) solubility using eutectic products, while determining saturation levels as well as the stability of the solution, while attaining the goal of adequate to excellent recovery yield.

In an embodiment, the present invention also is able to solubilize nylon 6,6 (CAS 32131-17-2) using eutectic products, while determining saturation levels as well as the stability of the solution, while attaining the goal of adequate to excellent recovery yield.

In an embodiment, the present invention relates to the recovery of nylon from textile waste containing mixed fibers and pigmented fabrics using eutectic products. In a variation, the present invention also relates to determining the saturation maximum for solubility, the conditions as well as ascertaining the stability of the resulting solution. By ascertaining the various solubilization parameters and other parameters as they relate to recycling and/or recovery, the yield of recovery can effectively also be maximized.

In an embodiment, the present invention relates to extracting dyes from nylon textile to enhance the purity of nylon recovered using the eutectic solvent products of the present invention.

For the sake of convenience the various tested systems and their components are listed here:

MAL (1:5): Malic Acid : Lactic Acid

LC (7:1): Lactic Acid : Citric Acid

UL (1:3) : Urea : Lactic Acid

TL (1:1,3) : Thymol : Lactic Acid

TOA (1:1) : Thymol : Oleic Acid

TACH (1:4:67): Tartaric Acid: Citric Acid : Water

LCMA (1: 0.07:0.11) : Lactic Acid : Citric Acid : Malic Acid

TAMAL (1.1,1:30): Tartaric Acid : Malic Acid : Lactic Acid

UBcPG (1.0.5:1.5): Urea : Coconut Betaine : 1,2-propanediol

BcC (1:0.25): Coconut Betaine : Citric Acid

BcPG (1:4.5): Coconut Betaine : Propanodiol

UBcPG (1:0.5:1.5): Urea : Coconut Betaine : 1,2 propanediol

BcL (1:1): Coconut Betaine : Lactic Acid

LBcPG (1:1:1): Lactic Acid : Coconut Betaine : 1,2 propanediol

It should be noted that mixtures of the various systems may have also been tested.

### Examples

Solubility tests of Nylon 6 pellets (CAS 25038-54-5) were carried out at atmospheric pressure and 80 °C with a stirring rate of 300 rpm. The following eutectic systems were tested: MAL ((1:5): Malic Acid : Lactic Acid), LC ((7:1): Lactic Acid : Citric Acid), 50% wt mixture of MAL/LC, UL ((1:3) : Urea : Lactic Acid) and 50% wt mixture of TL/ TOA (TOA is (1:1) : Thymol : Oleic Acid). Into the various tested eutectic systems, 0.05 g of nylon 6 pellets were gradually added into 5 g of solvent. The various solvent systems were tested until complete solubilization.

Solubility tests of Nylon 6,6 pellets (CAS 32131-17-2) were carried out at atmospheric pressure and 100°C with a stirring rate of 300 rpm. The following eutectic systems were tested: MAL, 50% wt mixture MAL/LC , TACH ((1:4:67): Tartaric Acid: Citric Acid : Water), LCMA ((1: 0.07:0.11) : Lactic Acid : Citric Acid : Malic Acid), TAMAL ((1.1,1:30): Tartaric Acid : Malic Acid : Lactic Acid) and 50% wt mixture TAMAL/LCMA. Gradual additions of 0.05 g nylon 6,6 pellets in 5 g of solvent were tested until complete solubilization occurred.

The solubility tests were carried out using 100% nylon fiber of different colors including black, white and blue nylons; moreover, mixes such as 80% nylon and 20% elastane green fibers were also tested at atmospheric pressure and 100 °C with a stirring rate of 300 rpm using a 50% wt mixture TAMAL/LCMA. In this experiment, gradual addition of 0.1 g of the 80% nylon and 20% elastane green fiber mix was added into 10 g of solvent.

Furthermore, the extraction of dyes were tested using 100% nylon blue fibers at atmospheric pressure and 80 °C with UBcPG (1:0.5:1.5) Urea : Coconut Betaine : 1,2-propanediol using 0.5 of the fiber in 5 g of solvent.

In light of these above tests, and to illustrate aspects of the invention, the invention will be discussed in connection with the figures.

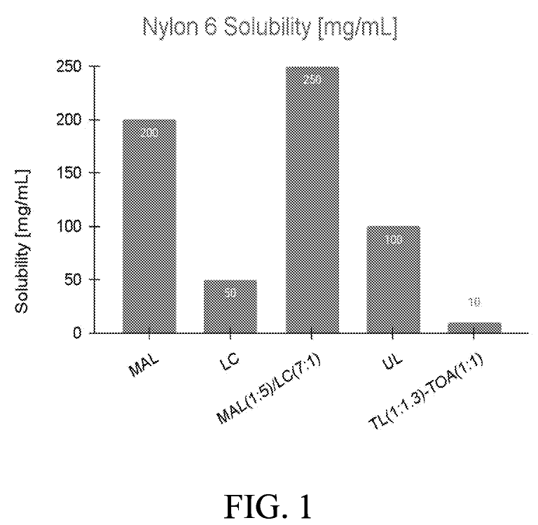

As can be seen in FIG. 1, the results show that the eutectic mix that comprises the MAL/LC mixture is the optimal solvent for nylon 6 among the various tested options. Therefore, it was determined that this eutectic solvent mix was to be used for further tests.

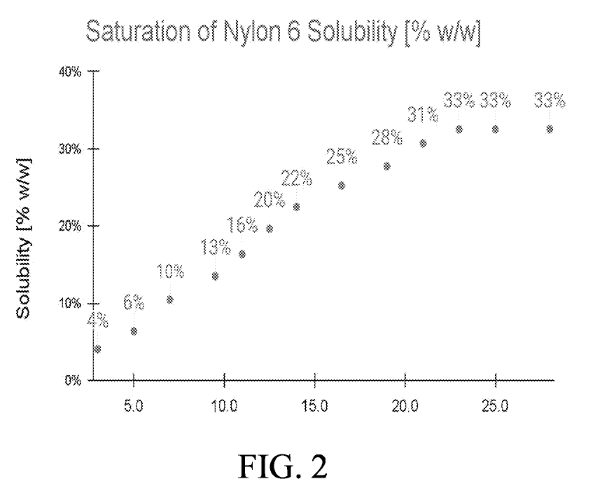

Saturation tests were conducted in order to understand the solubilization capacity of the mixture MAL/LC. It was determined that saturation was reached when the nylon 6 attained a concentration of 32.5% (w/w) after 23 hours of continuous stirring, as shown in FIG. 2. This saturation point was confirmed by the inability to dissolve an additional 50 mg of solute with an additional 5 hours of stirring.

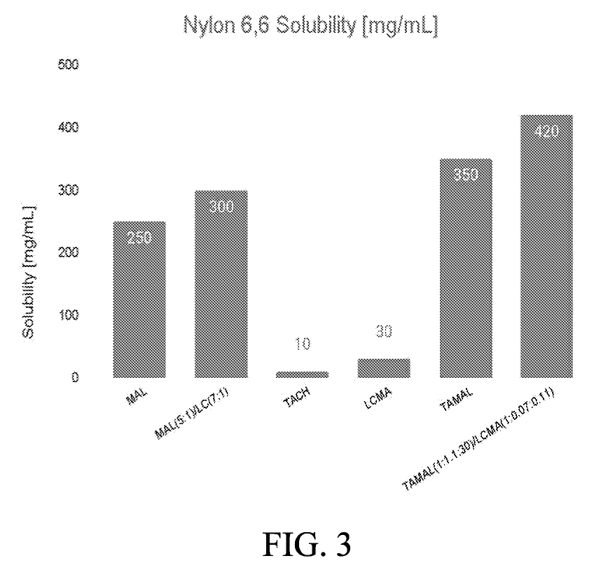

For nylon 6,6, the solubility screening results are shown in FIG. 3. The results demonstrate that the mixture TAMAL/LCMA exhibited the highest solubility (42%) under identical conditions. Thus, the mixture TAMAL/LCMA was selected for further studies with nylon 6,6.

In an effort to see what parameters affected the dissolution of the various polymers, various parameters were tested. Initially, tests were performed to ascertain the influence of stirring on dissolution.

### Stirring Influence

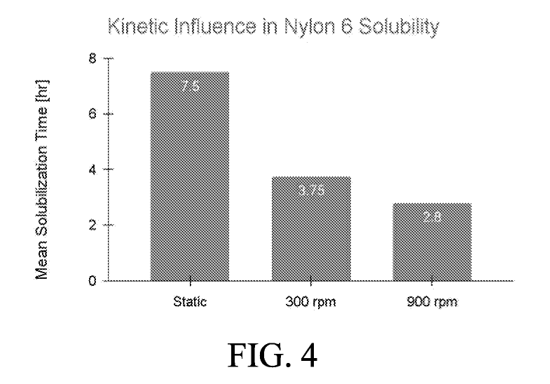

The impact of stirring on solubility time was investigated by comparing the dissolution rates of three batches of 0.15 g nylon 6 pellets in 10 g of solvent at 85 °C. Each batch was subjected to different stirring conditions: static, 300 rpm, and 900 rpm. The results, illustrated in FIG. 4, clearly demonstrate that stirring is a critical factor for the solubilization process. The solubilization time decreased with increasing stirring speed with a stirring speed of 900 rpm producing close to optimal results.

Subsequently, the effect of temperature on dissolution was evaluated.

### Temperature Influence

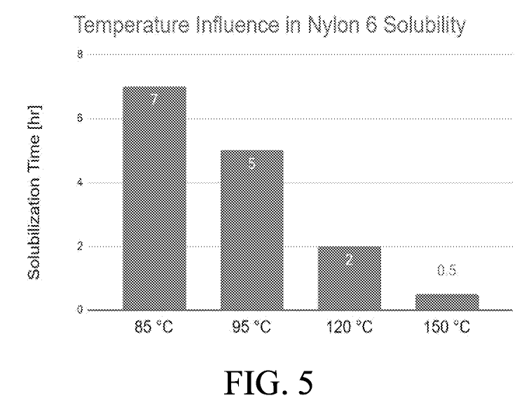

The effect of temperature on solubility time was evaluated by comparing the dissolution rates of four batches of 0.2 g nylon 6 pellets in 4 g of solvent without stirring. Stirring was omitted so that the effect of temperature could be evaluated without any putative interference from the stirring rate. Each batch was heated in a hot bath at different temperatures: 85°C, 95°C, 120°C, and 150°C. The results, shown in FIG. 5, clearly demonstrate that increasing temperature is a substantial factor in accelerating the solubilization process.

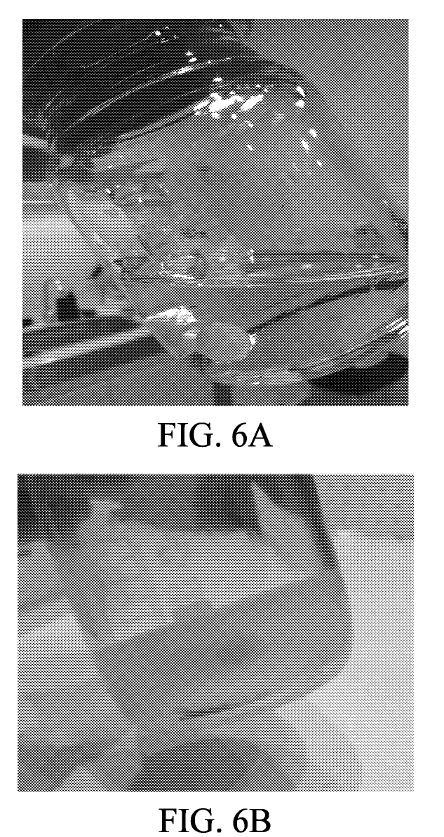

For nylon 6,6, the influence of temperature on solubility was tested by adding 0.5 g of pellets to 5 g of solvent at 120°C using a 300 rpm stirring rate. Complete solubilization was achieved within 2 hours, as illustrated in FIG. 6a. Furthermore, the solvent solidified completely upon cooling to room temperature, as shown in FIG. 6b. It's important to note that the product acquired a yellowish color after the initial stage. Thus, it appears that an elevated temperature with a decent stirring rate (of about 300 rpm) can solubilize the polymer.

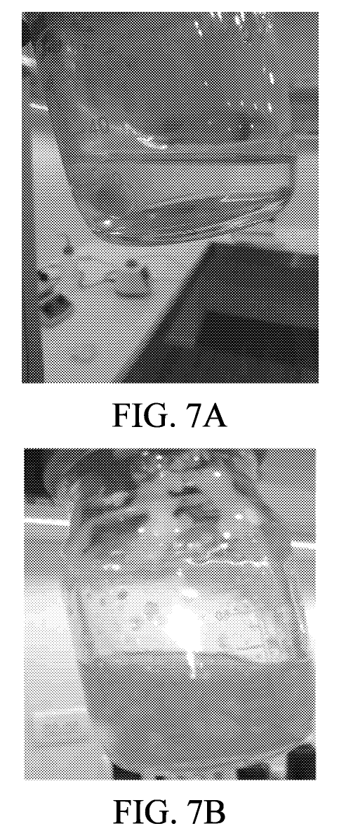

To further investigate the generation of the yellowish color, nylon 6,6 pellets were heated at 100°C. While the intensity of the yellow coloration decreased during the first hour of heating, as depicted in FIG. 7a, it eventually stabilized at the same level as that observed at 120°C after 3 hours of processing (FIG. 7b). Thus, it appears that color can be diminished by heating the polymer to a certain temperature after which the loss of color becomes more limited with increasing temperature.

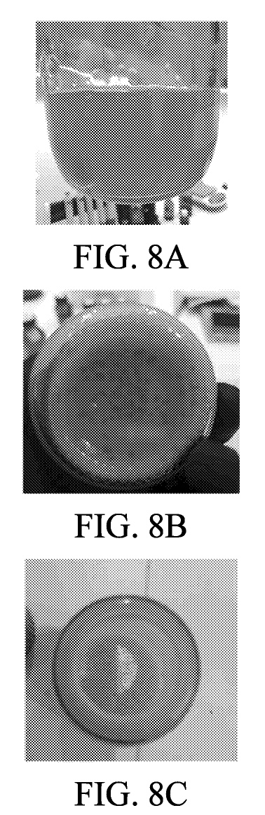

The process necessitated a substantial increase in the time for complete solubilization, with the solubilization time exceeding 15 hours with stirring (FIG. 8a). The product solidified upon cooling to ambient temperature, as depicted in FIGS. 8b and 8c.

Subsequently, experiments were performed to ascertain if different forms (e.g., fibers) and different colors of the polymer using eutectic solvents gave good results to solubilization and recovery.

### Textile Fibers Solubility

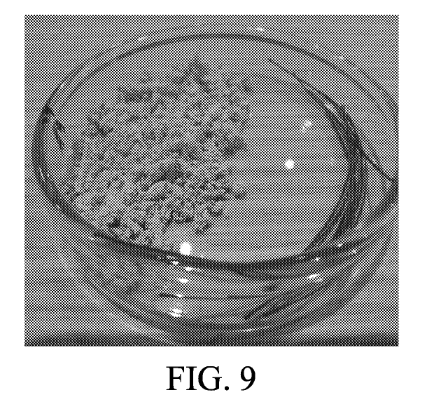

For colored fibers, the dissolution process was conducted using 1 g of fiber in 10 g of a mixture comprising TAMAL/LCMA at 100°C, with a stir rate of300 rpm, and at atmospheric pressure. Interestingly, this process, which required 1 hour to complete solubilization, resulted in a decrease in fiber coloration as can be observed in the recovered nylon using water as antisolvent (FIG. 9 illustrates the recovered nylon (left) and the original fiber is shown on the right).

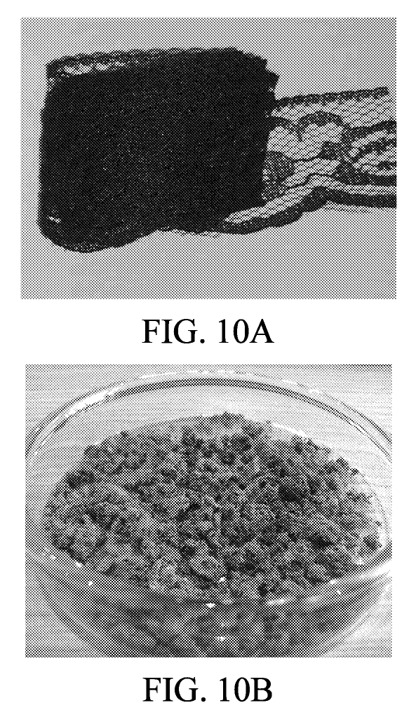

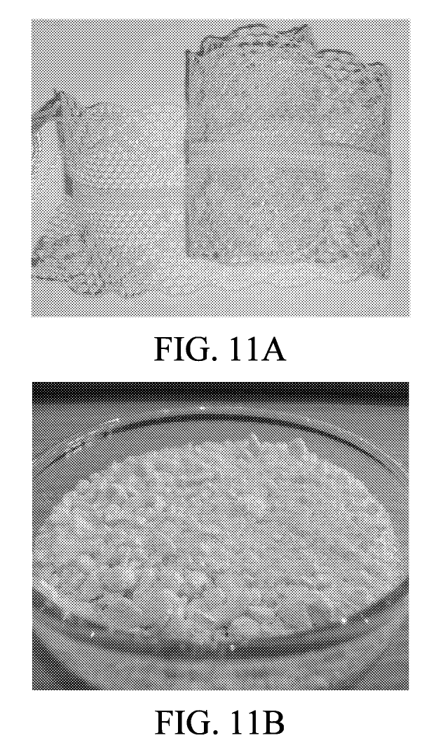

In the case of black and white colored fibers, which both were solubilized through successive additions of 0.5 g of fibers in 10 g of solvent at 100 °C with a stir rate of 300 rpm. The solubilization process also showed a discoloration, which is shown in FIG. 10a (original black fiber), FIG. 10b (recovered black nylon). FIG. 11a (original white fiber) and FIG. 11b (recovered white nylon) show the results with a white nylon.

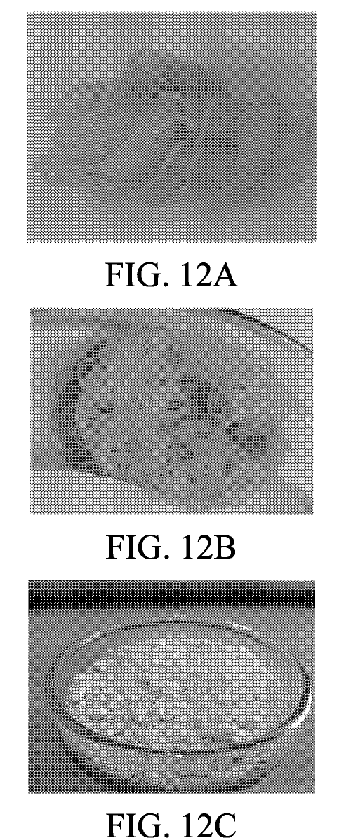

In the case of a green colored fiber, which comprises 80% of nylon and 20% elastane, a selective dissolution mechanism was observed. The solubilization process was carried out through successive additions of 0.5 g of fiber in 10 g of solvent at 100 °C with a stir rate of 300 rpm. Elastane was recovered without modifications (only loss of coloration) and nylon was recovered as shown in FIGS. 12a12b and 12c, respectively. In particular, FIG. 12 a. is a textile mixture of nylon and elastane. FIG. 12 b. is the elastane that remains intact. FIG. 12 c. is the recovered nylon.

### Dissolution Amount

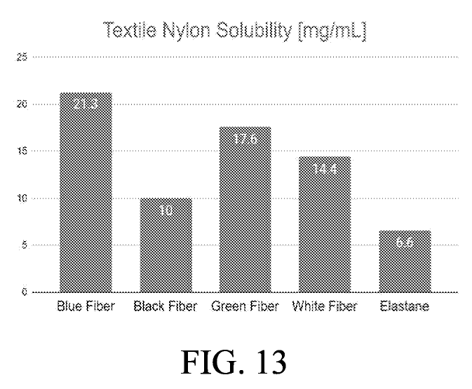

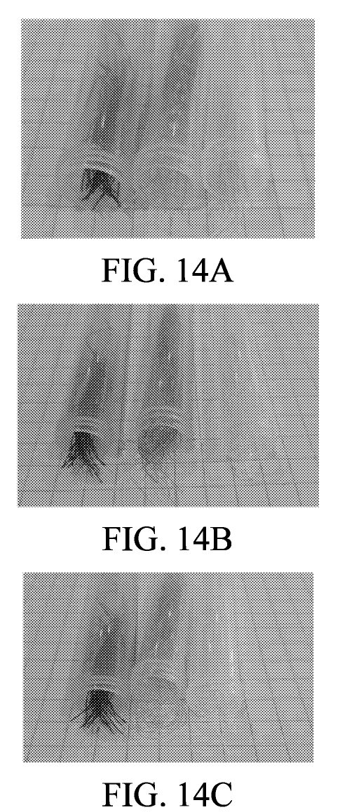

The dissolution maximal amounts of the all tested fiber are shown in FIG. 13. Blue fiber demonstrated the best solubility with elastane demonstrating the poorest. Green fiber, white fiber, and black fiber, respectively demonstrated intermediate amounts in decreasing order.

### Analysis of Remaining Color in Fibers

Discoloration tests were conducted using 0.01 g of colored blue nylon fiber in 1 g of solvent. Temperatures of 70, 80, and 90 °C were evaluated without stirring. While a significant difference was observed between 70 and 80°C, the variation between 80 and 90°C was minimal. Consequently, 80 °C was chosen as the optimal temperature for subsequent assays as there did not appear to be much additional benefit to increasing the temperature beyond 80^{o}C.

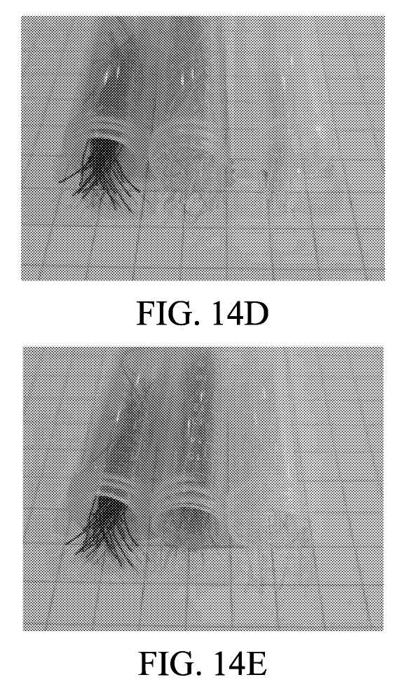

The most successful products are shown in FIG. 14. In every case in the images, the original fibers are shown on the left, followed by decolorated fibers at 10% (w/w) in the middle and 5% (w/w) of fiber in pure solvent at the right. All of these experiments were carried out at 80 °C for 1 hr.

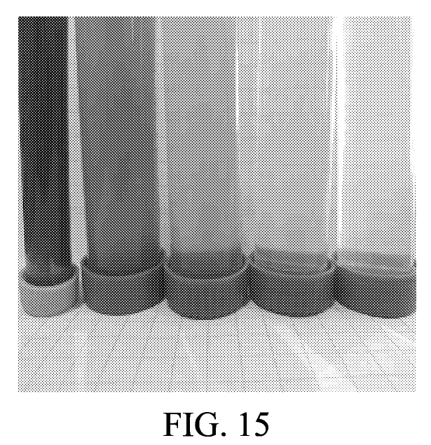

As can be ascertained by the images in FIGS. 14a-e, the most effective extraction was achieved using UBcPG. In addition, washing studies were carried out using 4 distilled water additions using equal volume of solvent for each extraction. The results are shown in FIG. 15. As can be seen in FIG. 15 each subsequent extraction resulted in a sample that was less colored than the previous.

### Analysis of Remaining Color in Recover Nylon

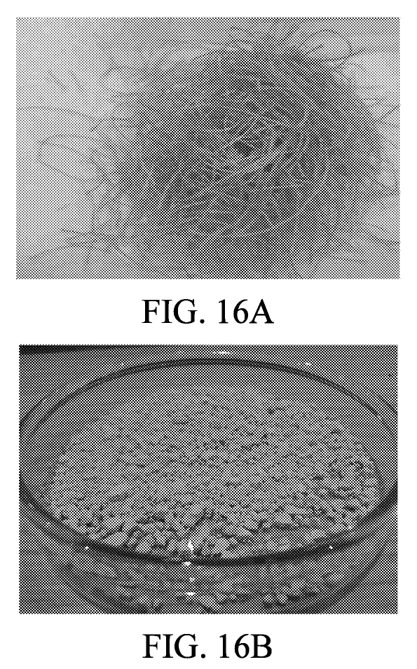

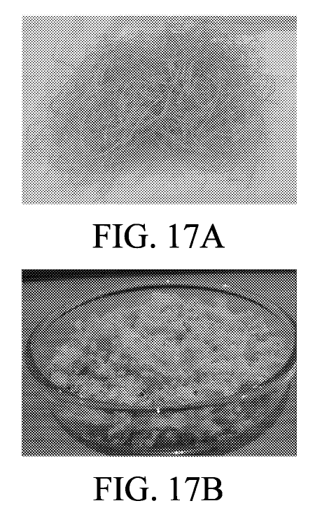

FIGS. 16a and 16b illustrate the color of nylon fibers after bleaching (FIG. 16A) and recovered (FIG. 16B) at 10% (w/w) fibers in pure UBcPG. It should be noted that the form of the recovery differs with fibers being present as the initial product after bleaching and rounded particles present after recovery. Similarly, FIG. 17a and 17b illustrate the same comparable tests (to FIG. 16A and 16B) performed at 5% (w/w) fibers in pure UBcPG. It should be noted that the recovered product in FIG. 17B is more similar to the starting material.

Subsequently, experiments were conducted to ascertain the yields of recovery of various products and processes.

### Simultaneous solubilization and discoloration of nylon

Building upon previous findings, a novel approach was adopted involving the simultaneous blending of the products of the present invention for both decolorization and pigment extraction. This strategy aimed to achieve complete dissolution of nylon and concomitant pigment removal, thereby optimizing the recycling process and reducing environmental impact.

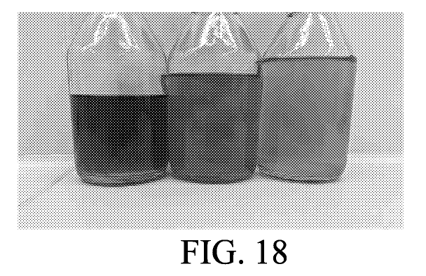

In a series of experimental procedures, a 50:50 w/w mixture of TAMAL/LCMA and UBcPG was prepared and maintained at a temperature of 80 °C for a duration of 1 hour. For each individual experiment within the series, a 0.01 g sample of blue-colored nylon fiber was submerged in 1 g of the prepared solvent mixture. Following a period of incubation in the solvent mixture, the nylon fiber underwent a washing procedure consisting of three sequential rinses with water. The supernatants resulting from each of these washing steps were collected and are visually represented in FIG. 18, arranged from left to right in the order in which the washing steps were performed.

A progressive loss of color is evident from left to right as a result of repeated washings. The white precipitate observed in the initial wash is attributed to the decolorized nylon.

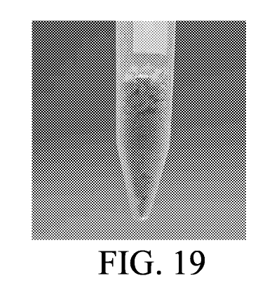

After this, precipitated nylon was filtered as explicated before. FIG. 19 shows the nylon achieved after the application of 3 times of simultaneous solubilization and discoloration of nylon.

As can be seen, a white nylon can be reached with this methodology. In this way this approach can be used to attain a total decoloration of textile fibers.

### Yield in Recovered Polyamide

Yield analysis of recovered nylon was conducted by dissolving 3 g of nylon 6 in 10 g of MAL/LC mixture at 120 °C with a stirring speed of 300rpm for 2 hr. After filtration, washing and drying at 45 °C for 24 hr., the mass recovered was ascertained to be 3.38 g, which corresponds to a yield of 113%.

Nylon 6,6 was also tested using 4 g of pellets in 10 g of a TAMAL/LCMA mixture at 120 °C with a stirring speed of 300 rpm for 2hr. After filtration, washing and drying at 45 °C for 24hr, the mass recovered was ascertained to be 4.08 g for nylon 6,6, corresponding to a 102% yield recovery.

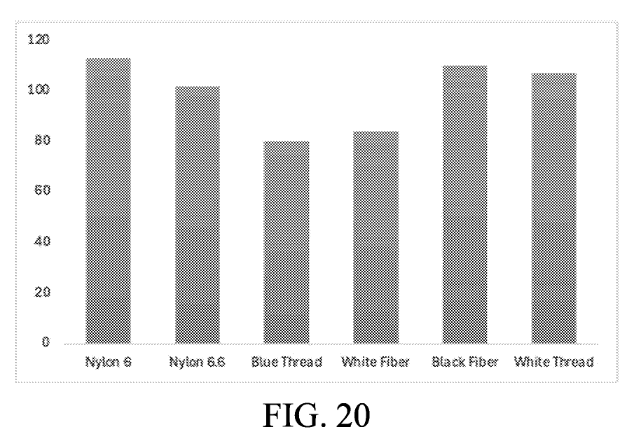

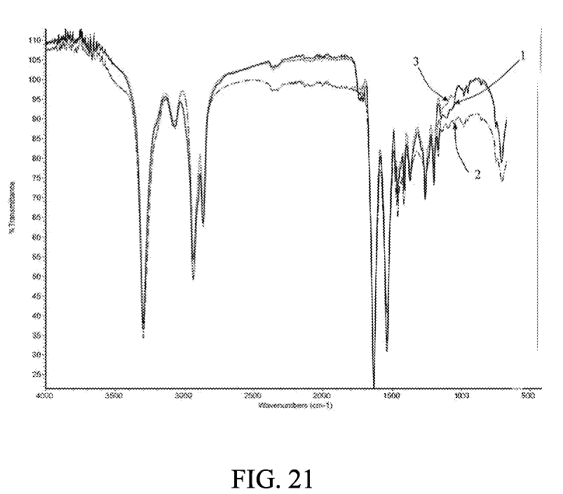

Similarly, for a textile blue nylon, the recovery yield was assessed using an initial mass of 1 g in 10 g of a TAMAL / LCMA eutectic mixture at 100 °C with a stirring speed of 300 rpm for 1hr. The yield of blue nylon was ascertained with and without the discoloration process. A summary of the yields for the various polymer recoveries is shown in FIG. 20.

The recovery process was carried out using 2 ml of the nylon solution combined with 8 ml of water and subjected to vortex mixing for 1 minute. The samples were then filtered, washed three times with distilled water, and dried at 45°C for 48 hours. Each experiment was conducted in triplicate.

Besides, several tests were performed using a textile white nylon fiber, a textile black nylon fiber, and a textile white nylon thread through addition of the fibers into a TAMAL/LCMA eutectic mix.

The mean of the various yields of these products using the recovery process enumerated above is shown in FIG. 18. Because of evident turbidity remaining in the filtration water process, it was determined that yield could be increased by using more efficient filtration equipment.

The following conclusions can be drawn from the figures and the experiments and data associated therewith.

The TAMAL/LCMA mixture exhibited remarkable solubility performance for nylon 6, nylon 6,6, and textile nylon, even when blended with other polymers like elastane. Furthermore, nylon 6 and 6,6 can be efficiently recovered using a straightforward and effective method that utilizes water as an antisolvent.

Additionally, UBcPG has emerged as a promising solvent for pigment extraction from textile nylon fibers under mild laboratory conditions. The optimal proportion of fiber for pigment extraction in pure UBcPG was found to be close to 10% w/w. It was found that decreasing the relative amount of this value does not give good discoloration quality.

FIG. 19 shows the nylon attained after the application of 3 times of simultaneous solubilization and discoloration of nylon.

FIG. 20 shows a summary of the yields for the various polymer recoveries.

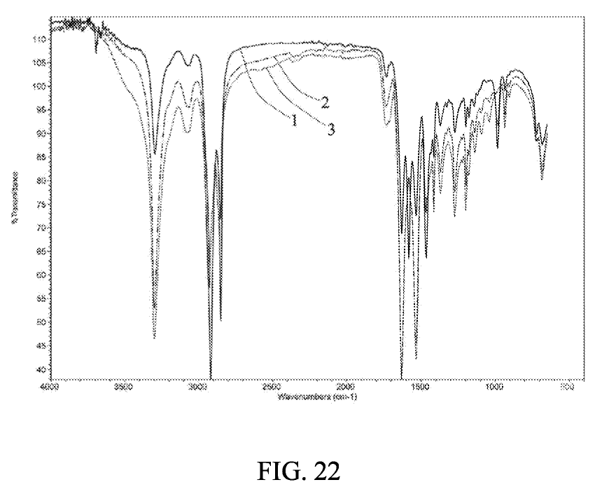

FIGS. 21 and 22 depict FTIR-ATR (Fourier Transform Infrared – Attenuated Total Reflectance) Spectra demonstrating that after recovery, nylon 6,6 and nylon from white thread (solid 1 - line) maintain the same conformation and structure as at the beginning (dash-dot 2 and dot – 3 lines).

In an embodiment, the present invention relates to a method of recovering and/or recycling a polymer using a eutectic solvent, wherein the method comprises solvating the polymer in the eutectic solvent to generate a solution, and subsequently isolating recovered polymer from the solvent. In a variation, the polymer comprises one or more members selected from the group consisting of polyamides, polyether ether ketone (PEEK), polyphenylene sulfide (PPS), polyester, polyurethane, polystyrene, and polyethylene terephthalate (PET), or mixtures thereof. In a variation, the polymer is a polyamide selected from the group consisting of nylon and nylon 6,6, or mixtures thereof. In a variation, the polymer is a mix of a polyamide and a polyurethane. In a variation, the polyamide is nylon or nylon 6,6 and the polyurethane is elastane. In a variation, the method further comprises a step of removing a color from the polymer. In a variation, the color is blue, green, or black.

In an embodiment, the present invention relates to a method of recovering and/or recycling a polymer using a eutectic solvent, wherein the recovery yield is calculated and the yield is greater than 20%. Alternatively, the yield is greater than 80%. In a variation, a combination of the polymer and the eutectic solvent is subjected to a temperature of greater than 70^{o}C. In a variation, the combination of the polymer and the eutectic solvent is subjected to a stir rate of at least about 300 rpm. In a variation, the method further comprises a step of washing and drying the recovered polymer. In a variation, the eutectic solvent is one or more members selected from the group consisting of:

MAL (1:5): Malic Acid : Lactic Acid;

LC (7:1): Lactic Acid : Citric Acid;

UL (1:3) : Urea : Lactic Acid;

TL (1:1,3) : Thymol : Lactic Acid;

TOA (1:1) : Thymol : Oleic Acid;

TACH (1:4:67): Tartaric Acid: Citric Acid : Water;

LCMA (1: 0.07:0.11) : Lactic Acid : Citric Acid : Malic Acid;

TAMAL (1.1,1:30): Tartaric Acid : Malic Acid : Lactic Acid;

UBcPG (1.0.5:1.5): Urea : Coconut Betaine : 1,2-propanediol;

BcC (1:0.25): Coconut Betaine : Citric Acid;

BcPG (1:4.5): Coconut Betaine : Propanodiol;

UBcPG (1:0.5:1.5): Urea : Coconut Betaine : 1,2 propanediol;

BcL (1:1): Coconut Betaine : Lactic Acid; and

LBcPG (1:1:1): Lactic Acid : Coconut Betaine : 1,2 propanediol; or mixtures thereof.

In a variation, the eutectic solvent comprises TAMAL/LCMA, MAL/LC, or TL/ TOA. In a variation, the solvating occurs at a temperature of at least 85^{o}C and at a stir rate of at least 300 rpm.

In an embodiment, the present invention relates to a method of removing color from a polymer, said method comprising administering a eutectic solvent to the polymer, wherein said eutectic solvent is a member selected from the group consisting of:

MAL (1:5): Malic Acid : Lactic Acid;

LC (7:1): Lactic Acid : Citric Acid;

UL (1:3) : Urea : Lactic Acid;

TL (1:1,3) : Thymol : Lactic Acid;

TOA (1:1) : Thymol : Oleic Acid;

TACH (1:4:67): Tartaric Acid: Citric Acid : Water;

LCMA (1: 0.07:0.11) : Lactic Acid : Citric Acid : Malic Acid;

TAMAL (1.1,1:30): Tartaric Acid : Malic Acid : Lactic Acid;

UBcPG (1.0.5:1.5): Urea : Coconut Betaine : 1,2-propanediol;

BcC (1:0.25): Coconut Betaine : Citric Acid;

BcPG (1:4.5): Coconut Betaine : Propanodiol;

UBcPG (1:0.5:1.5): Urea : Coconut Betaine : 1,2 propanediol;

BcL (1:1): Coconut Betaine : Lactic Acid; and

LBcPG (1:1:1): Lactic Acid : Coconut Betaine : 1,2 propanediol; or mixtures thereof.

LCMALeA (1:1:1:1): and several ratios more. Lactic Acid, Citric Acid, Malic Acid, Levulinic Acid.

LCMALeAPD (1:1:1:1:1): and several ratios more. Lactic Acid, Citric Acid, Malic Acid, Levulinic Acid, 1,3-propanediol.

In a variation, the color is blue, green, or black. In a variation, the method comprises several extraction steps with the eutectic solvent. In a variation, the eutectic solvent comprises UBcPG. It should be understood and it is contemplated and within the scope of the present invention that any feature that is enumerated above can be combined with any other feature that is enumerated above as long as those features are not incompatible. Whenever ranges are mentioned, any real number that fits within the range of that range is contemplated as an endpoint to generate subranges. In any event, the invention is defined by the below claims.

We claim:

1. A method of recovering and/or recycling a polymer using a eutectic solvent, wherein the method comprises solvating the polymer in the eutectic solvent to generate a solution, and subsequently isolating recovered polymer from the solvent.

2. The method of claim 1, wherein the polymer comprises one or more members selected from the group consisting of polyamides, polyether ether ketone (PEEK), polyphenylene sulfide (PPS), polyester, polyurethane, polystyrene, and polyethylene terephthalate (PET), or mixtures thereof.

3. The method of claim 2, wherein the polymer is a polyamide selected from the group consisting of nylon 6 and nylon 6, 6, or mixtures thereof.

4. The method of claim 2, wherein the polymer is a mix of a polyamide and a polyurethane.

5. The method of claim 4, wherein the polyamide is nylon or nylon 6,6 and the polyurethane is elastane.

6. The method of claim 1, wherein the method further comprises a step of removing a color from the polymer.

7. The method of claim 6, wherein the color is blue, green, or black.

8. The method of claim 1, wherein a yield of recovery is calculated and the yield is greater than 20%.

9. The method of claim 1, wherein a combination of the polymer and the eutectic solvent is subjected to a temperature of greater than 70^{o}C.

10. The method of claim 9, wherein the combination of the polymer and the eutectic solvent is subjected to a stir rate of at least about 300 rpm.

11. The method of claim 1, wherein the method further comprises a step of washing and drying the recovered polymer.

12. The method of claim 1, wherein the eutectic solvent is one or more members selected from the group consisting of:
MAL (1:5): Malic Acid : Lactic Acid;
LC (7:1): Lactic Acid : Citric Acid;
UL (1:3) : Urea : Lactic Acid;
TL (1:1,3) : Thymol : Lactic Acid;
TOA (1:1) : Thymol : Oleic Acid;
TACH (1:4:67): Tartaric Acid: Citric Acid : Water;
LCMA (1: 0.07:0.11) : Lactic Acid : Citric Acid : Malic Acid;
TAMAL (1.1,1:30): Tartaric Acid : Malic Acid : Lactic Acid;
UBcPG (1.0.5:1.5): Urea : Coconut Betaine : 1,2-propanediol;
BcC (1:0.25): Coconut Betaine : Citric Acid;
BcPG (1:4.5): Coconut Betaine : Propanodiol;
UBcPG (1:0.5:1.5): Urea : Coconut Betaine : 1,2 propanediol;
BcL (1:1): Coconut Betaine : Lactic Acid; and
LBcPG (1:1:1): Lactic Acid : Coconut Betaine : 1,2 propanediol; or mixtures thereof.
LCMALeA (1:1:1:1): and several ratios more. Lactic Acid, Citric Acid, Malic Acid,
Levulinic Acid.
LCMALeAPD (1:1:1:1:1): and several ratios more. Lactic Acid, Citric Acid, Malic Acid,
Levulinic Acid, 1,3-propanediol.

13. The method of claim 2, wherein the eutectic solvent is one or more members selected from the group consisting of:
MAL (1:5): Malic Acid : Lactic Acid;
LC (7:1): Lactic Acid : Citric Acid;
UL (1:3) : Urea : Lactic Acid;
TL (1:1,3) : Thymol : Lactic Acid;
TOA (1:1) : Thymol : Oleic Acid;
TACH (1:4:67): Tartaric Acid: Citric Acid : Water;
LCMA (1: 0.07:0.11) : Lactic Acid : Citric Acid : Malic Acid;
TAMAL (1.1,1:30): Tartaric Acid : Malic Acid : Lactic Acid;
UBcPG (1.0.5:1.5): Urea : Coconut Betaine : 1,2-propanediol;
BcC (1:0.25): Coconut Betaine : Citric Acid;
BcPG (1:4.5): Coconut Betaine : Propanodiol;
UBcPG (1:0.5:1.5): Urea : Coconut Betaine : 1,2 propanediol;
BcL (1:1): Coconut Betaine : Lactic Acid; and
LBcPG (1:1:1): Lactic Acid : Coconut Betaine : 1,2 propanediol; or mixtures thereof.

14. The method of claim 3, wherein the eutectic solvent is one or more members selected from the group consisting of:
MAL (1:5): Malic Acid : Lactic Acid;
LC (7:1): Lactic Acid : Citric Acid;
UL (1:3) : Urea : Lactic Acid;
TL (1:1,3) : Thymol : Lactic Acid;
TOA (1:1) : Thymol : Oleic Acid;
TACH (1:4:67): Tartaric Acid: Citric Acid : Water;
LCMA (1: 0.07:0.11) : Lactic Acid : Citric Acid : Malic Acid;
TAMAL (1.1,1:30): Tartaric Acid : Malic Acid : Lactic Acid;
UBcPG (1.0.5:1.5): Urea : Coconut Betaine : 1,2-propanediol;
BcC (1:0.25): Coconut Betaine : Citric Acid;
BcPG (1:4.5): Coconut Betaine : Propanodiol;
UBcPG (1:0.5:1.5): Urea : Coconut Betaine : 1,2 propanediol;
BcL (1:1): Coconut Betaine : Lactic Acid; and
LBcPG (1:1:1): Lactic Acid : Coconut Betaine : 1,2 propanediol; or mixtures thereof.

15. The method of claim 14, wherein the eutectic solvent comprises TAMAL/LCMA, MAL/LC, or TL/ TOA.

16. The method of claim 14, wherein the solvating occurs at a temperature of at least 85^{o}C and at a stir rate of at least 300 rpm.

17. A method of removing color from a polymer, said method comprising administering a eutectic solvent to the polymer, wherein said eutectic solvent is a member selected from the group consisting of:
MAL (1:5): Malic Acid : Lactic Acid;
LC (7:1): Lactic Acid : Citric Acid;
UL (1:3) : Urea : Lactic Acid;
TL (1:1,3) : Thymol : Lactic Acid;
TOA (1:1) : Thymol : Oleic Acid;
TACH (1:4:67): Tartaric Acid: Citric Acid : Water;
LCMA (1: 0.07:0.11) : Lactic Acid : Citric Acid : Malic Acid;
TAMAL (1.1,1:30): Tartaric Acid : Malic Acid : Lactic Acid;
UBcPG (1.0.5:1.5): Urea : Coconut Betaine : 1,2-propanediol;
BcC (1:0.25): Coconut Betaine : Citric Acid;
BcPG (1:4.5): Coconut Betaine : Propanodiol;
UBcPG (1:0.5:1.5): Urea : Coconut Betaine : 1,2 propanediol;
BcL (1:1): Coconut Betaine : Lactic Acid; and
LBcPG (1:1:1): Lactic Acid : Coconut Betaine : 1,2 propanediol; or mixtures thereof.

18. The method of claim 17, wherein the color is blue, green, or black.

19. The method of claim 17, wherein the method comprises several extraction steps with the eutectic solvent.

20. The method of claim 17, wherein the eutectic solvent is UBcPG.
